(19) United States
(12) Patent Application Publication
(10) Pub. No.: US 2022/0318811 A1
(43) Pub. Date: Oct. 6, 2022

(54) Methods for Card-Based Payment Options and Hybrid Payment Authorization

(71) Applicant: Mirabito Holdings, Inc., Binghamton, NY (US)

(72) Inventors: Brent Strignano, Binghamton, NY (US); Abhineet Sharma, Binghamton, NY (US)

(21) Appl. No.: 17/309,637

(22) PCT Filed: Jun. 3, 2020
(86) PCT No.: PCT/US2020/035933

§ 371 Date: Jun. 11, 2021

(51) Int. Cl. G06Q 20/40; G06Q 20/38; G06Q 20/20

(52) U.S. Cl. CPC G06Q 20/4012; G06Q 20/3821; G06Q 20/204

(57) ABSTRACT

Methods and systems for hybrid payment authorization for an electronic payment transaction for card-based payment options providing a single hybrid payment authorization method and system having multiple operating states of online and offline and allowing for payment authorization for an electronic payment transaction for card-based payment options regardless of connectivity status between the payment authorization network.

### BACKGROUND

The field of invention relates generally to electronic payment transactions and more specifically to electronic payment authorization systems. Sometimes customers of goods or services want to make a purchase and pay for the purchase without using cash or checks, but rather want to pay with a payment form that necessitates an electronic payment transaction using an electronic payment processing system. Electronic payment transactions require an electronic payment processing system, and which inch de payment form may include, for example, card-based payment options, including debit cards, credit cards, and prepaid cards, such as stored-value cards, loyalty cards and gift cards. A requirement for an electronic payment processing system is a payment authorization system that confirms any card-based payment form presented the customer at the time of purchase, prior to the delivery of the goods or services being purchased.

Generally, electronic payment processing systems relating to card-based payment options include a customer, that is, a cardholder, and a merchant that sells goods and/or services to the customer and who accepts card-based payment options, and multiple banks and financial institutions that are responsible for payment authorization using credit card networks, and related functions. The electronic payment transaction is successfully completed only after the authorization, authentication, clearing and settlement steps are successfully completed. Logically, it follows that the payment authorization st be completed prior to the electronic payment transaction proceeding t yards completion. Typically, the payment authorization step begins with the cardholder presenting their card-based payment option to the merchant for payment. This is normally done at the point-of-sale terminal, which point-of-sale terminal is used to capture and to send the presented card details via an interact connection to a financial institution and then onto a network for payment authorization by requesting information such as the card-based payment option card number, card expiration date, billing address, credit card security code, and payment amount.

Known systems in the art relating to payment authorization during an electronic payment transaction have multiple disadvantages and multiple problems, as recognized and understood by one of ordinary skill in the art, including those disadvantages and problems that are described herein, without intending to be a complete list, including one or more of the following disadvantages and problems, namely, known electronic payment systems fail to offer a choice other than either a completely online system, that is, a system requiring a completely functioning Internet connection, or a completely offline, system, that is, a system operable only when an internet connection is not functioning; known electronic payment systems fail to allow for the separation of multiple services such as a processing application programming interface, a user interface website and a relational database management system; known electronic payment systems fail to provide a hybrid system, that is, a single hybrid payment authorization online and offline system as disclosed herein and therefore, know systems and methods fail to provide, for example but not limited to, guaranteed access to card-based payment option data required for authorization for card-based payment options; immediate and convenient access for customers to card-based payment options; multiple point-of-sale terminals that are functional for authorization without maintaining on them an entire database of customer card-based payment option data; one system having both and an online and offline state for card based payment options. Thus, there exists a need for novel and effective methods and systems relating to payment authorization during an electronic payment transaction that are not subject to the multiple disadvantages and problems of the prior art, including those described herein.

### SUMMARY OF INVENTION

An object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, including for example but not limited to, when the single hybrid system is online, as described herein, that is, a time when there is a completely functioning data connection, or when the single hybrid system is offline, as described herein, that is, a time when the data connection is not completely functioning, including whenever data connection is lost and/or there are technical problems with data connectivity and/or an authorization processor is down, for example but not limited to, unreachability and/or returning errors, and thereby such a hybrid system, that is, a hybrid system having multiple operating states provides enhancement of business by, at least but not limited to, increasing efficiency and/or increasing times when the customer may utilize card-based payment options.

Another object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, a hybrid system allowing for the separation of multiple sell/ices, as described herein, including whenever data connection is lost and/Or there are technical problems with data connectivity and/or an authorization processor is down, for example but not limited to, unreachability and/or returning errors, as described herein, which multiple services may be for example but not limited to, a processing application programming interface, a user interface website, and a relational database management system such as the SQL database, and which hybrid system allowing for the separation of multiple services thereby provides enhancement of business by, at least but not limited to, increasing efficiency and/or increasing times when the customer may utilize card-based payment options.

Yet another object of the invention is to provide novel and effective methods and systems for payment authorization during an electronic payment transaction, that is, to provide novel and effective methods and systems relating to card-based payment options and hybrid payment authorization, by utilizing the steps of the Methods and/or the systems all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, to provide a hybrid system having continuous point-of-sale operability for card-based payment options, as described herein, including whenever data connection is lost and/or there are technical problems with data connectivity and/or an authorization processor is down, for example but not limited to, unreachability and/or returning errors, as described herein, which point-of-sale operability thereby provides enhancement of business by, at least but not limited to, permitting the customer to utilize card-based payment options.

Yet another object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, to provide a hybrid system providing guaranteed access to card-based. payment option data required for authorization, as, described herein, including whenever data connection is lost and/or there are technical problems with data connectivity and/or an authorization processor is down, for example but not limited to, unreachability and for returning as described herein, which guaranteed access to card-based payment option data required the authorization thereby provides enhancement of business by, at least but not limited to, permitting the customer to utilize card-based payment options, and guaranteed access to card-based payment option data required for authorization thereby provides customers such as, for example but not limited to, emergency services customers having emergency services vehicles in need of fuel, guaranteed access to needed fuel purchases needed for emergency services by virtue of the availability to card-based payment options, especially, for example but not limited to, times such as bad and/or severe weather events and other situations when data connectivity is interrupted and/or especially in remote regions where such data connectivity interruption is likely to require extended time to repair.

Yet another object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, to provide a hybrid system providing immediate and convenient access to card-based payment option data required for authorization, as described herein, including whenever data connection is lost and/or there are technical problems with data connectivity and/or an authorization processor is down, for example but not limited to, unreachability and/or returning errors, as described herein, which immediate and convenient access to card-based payment option data required for authorization thereby provides enhancement of business by, at least but not limited to, increasing efficiency and/or permitting the customer to utilize card-based payment options, and which immediate and convenient access to card-based payment option data required for authorization immediate and convenient access to card-based payment option data required for authorization thereby provides customers such as, for example but not limited to, emergency services customers having emergency services vehicles in need of filet, access to needed fuel purchases needed for emergency services by virtue of the availability to card-based payment options, especially, for example but not limited to, times such as bad and/or severe weather events and other situations when data connectivity is interrupted and/or especially in remote regions and where such data connectivity interruption is likely to require extended time to repair.

Yet another object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, to provide a hybrid system providing multiple point-of-sale systems, that is, multiple point-of-sale terminals that are functional for authorization without maintaining on them. an entire database of customer card-based payment option data, as described herein, including whenever data connection is lost and/or there are technical problems with data connectivity and/or an authorization processor is down., for example but not limited to, unreachability and/or returning errors, as described herein, which providing multiple point-of-sale terminals that are functional for authorization without maintaining on them an entire database of customer card-based payment option data, thereby provides enhancement of business by, at least but not limited to, increasing efficiency and/or increasing times when the customer may utilize card based payment options.

Yet, another object of the invention is to provide novel and effective methods and systems for payment authorization during an electronic payment transaction, that is, to provide novel and effective methods and systems relating to card-based payment options and hybrid payment authorization, by utilizing the steps of the methods and/or the systems, all of which are described herein, as recognized and understood by one of ordinary skill in the art based upon this disclosure, to provide a hybrid system, that is, a single hybrid payment authorization online and offline system, that is, a hybrid payment authorization system having multiple operating states, as described herein, to provide a hybrid system hiving in a single system, both an online and an offline state, as described herein, including for example but not limited to, when the system is online, as described herein, that is, a time when there is a completely functioning data connection, or when the system is offline, as described herein, that is, a time who the data connection is not completely functioning including whenever data connection is lost and/or there are technical problems with data connectivity and/or an authorization processor is down, for example but not limited to, unreachability and/or returning errors, which hybrid system having in a single system, both an online and an offline state, thereby provides enhancement of business by, at least but not limited to, increasing efficiency and/or increasing times when the customer may utilize card-based payment options.

For each of the objects of the invention listed above and including but not limited to those objects of the invention described herein and those readily apparent and understood by one of ordinary skill in the art based upon this disclosure, there are provided multiple advantages and multiple solutions to one or more of hie multiple disadvantages and multiple problems of known methods and/or systems in the relevant prior art, including the art relating to payment authorization during an electronic payment transaction, which one or more of the multiple disadvantages and multiple problems of known methods and/or systems in the prior art are listed below, which list is not intended to be limiting and without intending to be a complete list, for example, known methods and/or systems in the prior art: fail to offer a choice other than either a completely online system, that is, a system requiring a completely functioning internet connection, or a completely offline system, that is, a system operable only when an internet connection is not functioning; fail, to allow for the separation of multiple services such as a processing application programming interface, a user interface website, and a relational database management system; fail to provide a hybrid system, that is, a single hybrid payment authorization online and, offline system, as described herein, that results in continuous point-of-sale operability for card-based payment options; fail to provide a hybrid system, that is, a single hybrid payment authorization online and offline system as described herein that results guaranteed access to card-based payment option data required for authorization for card-based payment options; fail to provide a hybrid system, that is, a single hybrid payment authorization online and offline system, as described herein, that results in immediate and convenient access for customers to card-based payment options; fail to provide a hybrid system, that is, a single hybrid payment authorization online and offline system, as described herein, that results in multiple point-of-sale terminals that are functional for authorization without maintaining on them an entire database of custom card-based payment option data; fail to provide a hybrid system, as disclosed herein that results in one system having both online and offline states for card-based payment options, that is, a single hybrid payment authorization online and offline system.

As, disclosed below in representative, multiple aspects of the invention, that is, aspects of the steps of the inventive methods and systems relating to card-based payment option and hybrid payment authorization, as recognized and understood by one of ordinary skill in the art based upon this disclosure, the representative, multiple aspects of the invention provide multiple advantages and multiple solutions readily recognized and understood by e of ordinary skill the art based upon this disclosure, including those described herein.

In one aspect, the invention provide ads and systems for payment authorization during an electronic payment transaction, that is, provides novel and effective methods and systems relating to card-based payment options and hybrid payment authorization, by utilizing the steps of the methods and/or the systems, as described herein, to provide a hybrid, system, that is, a single hybrid payment authorization online and offline system, that is, a hybrid payment authorization system having multiple operating states, as described herein, as recognized and understood by one of ordinary skill in the art based upon this disclosure, the methods and/or the systems including, inter alia, a customer presenting for payment a card-based payment option at a point-of-sale system, that is, a point-of-sale terminal in a store having a store identification number; and the point-of-sale terminal, that is, a POS system, that is, a POS terminal, requesting authorization for the d-based payment option from a local processing unit system, that is a LPI3 system, having the store identification number ant a uniform resource locator, that is, a URL, for a central server; and the LPU system having access to the central server, and whit central server having one or more servers providing multiple services, far example but not limited to, as described herein, a processing application programming interface, that is a processing API, a user interface application programming interface, that is a user interface API web server, a web server running a frontend user interface, that is, a frontend TI, a relational database management system such as the SQL database; and the LPU system <executing periodic synthetic test transactions to determine the status of the connectivity between the. POS terminal acid/or the LPU system and/or the central server and to set itself in one of three processing modes, that is online mode, offline mode, or dawn mode; and when the IT system is set in online mode, opening, an encrypted connection to the central server and requesting authorization; and the central server responding to the authorization request with processing data for the card-based payment option, or responding to the authorization request with a reject message, as described herein, such as “card not found” or “over limit” or “locked/in use”; and if the central server response is processing data for the card-based payment option, then utilizing the processing data to continue the transaction, or if the central server response is a reject message, then ending the transaction; and if the transaction continues, then creating a transaction object in the LPU system and held in memory; and if the processing data requires a personal identification number, that is a PIN, then either sending an invalid PIN message such as when the PIN entered by the customer is compared against the PIN list in the processing data and no match is found, as described herein, and the transaction ends, or continuing the transaction and storing a card result in the transaction object and sending to the POS terminal an authorization message; the POS terminal responding with the amount of the transaction and with any responses to prompts, both of which are recorded to the transaction object; and then the LPU system responding with a receipt message and wherein, if the card-based payment option, for example but not limited to, is a stored-value card, then the LPU system calculating the remaining balance to print on the receipt, message and the remaining balance is stored in the transaction object; and the POS terminal responding for one or more purchased items, with one or more product codes and quantity for each and price for each, all of which are stored in the transaction object; and the LPU system responding with a transaction complete message, and uploading the transaction object to the central server, unless int the case of failure to upload, then the LPU system is set to offline mode, and then the transaction object is stored in a local database, or unless in the case of the failure to store the transaction object in a local database, then the LPU system is set to down mode and then either the transaction object is logged to a local log file or, if unsuccessful, then the transaction object is held in memory until the next periodic synthetic test transactions wherein, if there is connectivity to the central server, then the transaction object is uploaded to the central server; and wherein the card-based payment option, for example but not limited to, is a standard credit card, stored-value card such as a loyalty card or a gift card, a debit card; and wherein the central server provides the multiple services utilizing one or more server farms having one or more servers in each group; and wherein one or more security policies and, one or more protection layers are applied to one or more groups based on group function; and wherein the processing data for the card-based payment option includes information, as described herein, for example but not limited to, customer account information, card-based payment option information, that is, the card information such as card number such as the International Organization for Standardization number, that is the ISO number, that is the sixteen-digit number unique to the card being presented as a card-based payment option, card expiration date, billing address, credit card security code, and payment amount, customer information, credit information, product restriction information, authentication information transactional information; and wherein the authorization message sent to the POS contains information from the processing data, as described herein, such as authorized spending limit, list of allowed products, request for additional data to be entered by the customer such as, for example but not limited to, as driver identification, purchase order number, vehicle number and vehicle odometer reading.

In another aspect, the invention provides novel and effective methods and systems for payment authorization during an electronic payment transaction, that is, provides novel and effective methods and systems relating to card-based payment options and hybrid payment authorization, by utilizing the steps of the methods and/or the systems, to provide a hybrid system, that is, a single hybrid, payment authorization online and offline system, that is, a hybrid, payment authorization system having multiple operating states, as described herein, as recognized and understood by one of ordinary skill inn the art based upon this disclosure, the methods and/or the systems including, inter alia, a customer presenting for payment a card-based payment option at a point-of-sale terminal in a store having a store identification number; and the point-of-sale terminal, that is POS to requesting authorization for the card-based payment option from a local processing unit system, that is a LPU system, having the store identification number and a uniform resource locator, that is, a URL, for a central server; and the LPL) system having access to the central server, and which central server having one or more servers providing multiple services, for example but not limited to, as described herein, a processing application programming interface, that is a processing API, a user interface application programming interface, that is a user interface API web server, a web server running a frontend, user interface, that is, a frontend UI, a relational database management system such as the SQL database; and the LPU system executing periodic synthetic test transactions to determine the status of the connectivity between the POS terminal and/or the ETU system and/or the central server and to set itself in one of three processing modes, that is online mode, offline mode, or down mode; and when the LPU system is set in offline mode, then retrieving from the offline list the processing data for the card-based payment option and continuing the transaction, or if the processing data for the card-based payment option is not found in the offline list, then rejecting the card-based payment option and responding with a system down message, and the transaction ends; and wherein the card-based payment option, for example but not limited to, is a standard credit card, stored-value card such as a loyalty card or a gift card, a debit card; and wherein the central server provides the multiple services utilizing one or more server farms having one or more servers in each group; and wherein one or more security policies and one or more protection layers are applied to one or more groups based on group function; and wherein the processing data for the card-based payment, option includes information, as described herein, for example but net limited to, customer account information, card-based payment option information, that is, the card information such as card number such as the International Organization for Standardization number, that is the ISO number, that is the sixteen-digit number unique to the card being presented as a card-based, payment option, card expiration date, billing address, credit card security code, and payment amount, customer information credit information, product restriction information authentication information, transactional information; and wherein the authorization message sent to the POS contains information from the processing data, as described herein, such information including for example, authorized spending limit, list of allowed products, request for additional data to be entered by the customer such as, for example but not limited to, as driver identification, purchase order number, vehicle number, vehicle odometer reading; and wherein the offline list is a list of the card-based payment options for customers containing a of cards and associated processing data, but not containing stored-value cards but rather, for example, only standard credit cards

In yet another aspect, the invention provides novel and effective methods and systems for payment authorization during an electronic payment transaction, that is, provides novel and effective methods and systems relating to card-based payment options and hybrid payment authorization, by utilizing the steps of the methods and/or the systems, to provide a hybrid system, that is, a single, hybrid payment authorization online and offline system, that is, a hybrid payment authorization system having multiple operating states, as described herein, as recognized and understood by one of ordinary skill in the art based upon this disclosure, the methods and/or the systems including, inter alia, a customer presenting for payment a card-based payment option at a point-of-sale terminal in a store having a store identification number; and the point-of-sale terminal, that is POS terminal, requesting authorization for the card-based payment option from a local processing unit system, that is a LPU system, having the store identification number and a uniform resource locator, that is, a URL, for a central server; and the LPU system having access to the central server, and which central server having one or more servers providing multiple services, for example but not limited to, as described herein, a processing application programming interface, that is a processing AP1, a user interface application programming interface, that is a user interface API web server, a Webserver running a frontend user interface, that is, a frontend UI, a oral database management system such as the SQL database; and the LPU system executing periodic synthetic test transactions to determine the status the connectivity between the POS terminal and/or the LPU system and/or the central server and to set itself in one of three processing modes, that is online mode, offline mode, or down mode; and when the LPU system is set in down mode, then the presented card-based payment option is rejected and the LPU system responds with a system down message and the transaction ends; and wherein the card-based payment option, for example but not limited to, is a standard credit card, stored-value card such as a loyalty card er a gift card, a debit card, and wherein the central server provides the multiple services utilizing one or more sewer arms having one or more servers in each group; and wherein one or more security policies and one or more protection layers are applied to one or more, groups based on group function; and wherein the processing data for the card-based payment option includes information, as described herein, for example but not limited to, customer account information, card-based payment option information, that is, the card information such as card number such as the International Organization for Standardization number, that is the ISO number, that is the sixteen-digit number unique to the card being presented as a card-based payment option, card expiration date, billing address, credit card security code, and payment amount, customer information, credit information, product restriction information, authentication information, transactional information and wherein the authorization message sent to the POS contains information from the processing data, as described herein, such as authorized spending limit, list of allowed. products, request for additional data to be entered by the customer such as, for example but not limited to, as driver identification, purchase order number, vehicle number, vehicle odometer reading.

### BRIEF DESCRIPTION OF THE DRAWINGS

The detailed description and exemplary embodiments may refer to the accompanying drawings and figures, which drawings and figures are disclosed as illustrative examples and not intended to be limiting, and which drawings and figures provide multiple characteristics and multiple advantages of the invention recognized and understood by one of ordinary skill in the art based upon this disclosure. Note that the disclosure herein will readily be recognized and understood by one of ordinary skill in the art to have broad usefulness and application. While some exemplary embodiments are disclosed for illustrative purposes, some embodiments, such as adaptations, variations, modifications, and equivalent arrangements, are implicitly disclosed by the embodiments described herein and fall within the scope of the invention. Other objects, features, aspects and advantages of the invention will be readily be recognized and understood by one of ordinary skill in the art upon reference to, and as provided in the following detailed descriptions of multiple embodiments, and for some embodiments, with reference to the accompanying drawings, which are briefly described below:

FIG. 1 is an illustration of a chart of exemplary steps of the invention in accordance with an embodiment of the invention as recognized and understood by one of ordinary skill in the art based upon this disclosure.

FIG. 2 is an illustration of a chart of exemplary steps of the invention in accordance with an embodiment of the invention as recognized and understood by one of ordinary skill in the art based upon this disclosure.

FIG. 3 is, an illustration of a chart o exemplary steps of the invention in accordance with an embodiment of the invention as recognized and understood by one of ordinary skill in the art based upon this disclosure,

### DETAILED DESCRIPTION

Embodiments of the invention are described in detail herein and include the features and/or aspects and/or elements described in detail with respect to certain illustrative exemplary embodiments that may be combined and sub-combined in and/or with van(s other embodiments as recognized and understood by one of ordinary skill in the art. Also, some embodiments, whether individually and/or collectively, may be components of a larger system, wherein some steps of some embodiments >may take precedence over and/or otherwise modify some steps of some embodiments and/or the application of some steps of some embodiments, as recognized and understood by one of ordinary skill in the art. This detailed description, including in the description of the terms defined below, discloses objects, features, aspects and advantages of the embodiments of this disclosure, as are readily recognized and understood by one of ordinary skill in the art, and the objects, features, aspects and advantages provide multiple solutions to the multiple disadvantages and problems of known methods. The disclosure of the embodiments herein is illustrative and exemplary of the invention.

The terminology used herein for describing particular illustrative example embodiments, is not intended to be limiting of the invention. Thus, as used herein, the singular forms “a” and “an” and “the” are intended to include the plural forms as well, unless the context clearly indicates otherwise. The terms “comprises” and “includes” and “comprising” and “including” when used, in this specification, specify the presence of stated features, integers, steps, operations, elements, and/or components, but do not preclude the presence and/or addition of one or more other features, integers, steps, operations, elements, components, and/or groups thereof, The term “or” is intended to mean an inclusive “or” rather than an exclusive “or”, that is, unless specified otherwise, or clear from context, so that “X employs A or B” is intended to mean any of the natural inclusive permutations, namely, if X employs A; X employs B; or X employs both A and B, then “X employs A or B” is satisfied under any of the foregoing instances. Unless otherwise defined, all terms used herein, including technical and scientific terms, have the same meaning as recognized and understood by one of ordinary Skill in the art m the art to which this disclosure belongs. Terminology, as defined in commonly-used dictionaries, should be interpreted as hying a meaning that is consistent with the meaning in the context of the relevant art and should not be interpreted in an idealized and/or overly-formal sense unless expressly so defined herein. Terms may have meaning consistent with their meaning in the context of the relevant art to which this disclosure pertains, as well as additional and clarifying meaning and nuance given to them as defined herein.

The terms “first” and “second” and similar terms for ordinal numbers can be used herein to describe various steps and/or parts of methods and/or systems and these terms are not necessarily intended to be limiting, but rather these terms are used to distinguish certain steps and/or parts of methods and/or systems from certain other terms. Relative terms utilized herein to describe the invention are intended to encompass not only the relationships described herein and/or as depicted in the accompanying illustrative exemplary drawings and figures, but also different relationships evident to and recognized and understood by one of ordinal skill in the art upon reading this disclosure. The term “one or more”, as recognized and understood by one of ordinary skill in the art, means either one,, two, three, four, or more, as further indicated by the context in which it is used, and the term “plurality”, as recognized and understood by one of ordinary skill in the art, means two or more.

The terms listed below, as recognized and understood by one of ordinary skill in the art, and based upon the disclosure herein, are further defined with additional and/or clarifying meaning and/or nuance given to them as defined herein, but in any event, the terms listed below are provided to enhance understanding of the disclosure, and are not intended as necessarily limiting the scope of the disclosure, as would be recognized and understood by one of ordinary skill in the art, especially in light of the specification, and including the drawings and figures and abstract and accompanying claims, and the illustrative examples, which provide full and enabling disclosure of the invention.

The term “card-based payment options”, as recognized and understood by one of ordinary skill in the art, and based upon the disclosure herein, also includes meaning unless the context clearly indicates otherwise, payment for goods on services by a customer using a card such as, for example but not limited to, debit cards, credit cards, and prepaid cards such as stored-value cards, customer loyalty cards and store gift cards, and wherein the term “customer”, that is, a consumer of goods and/or services, as recognized and understood by one of ordinary skill in the art and based upon the disclosure herein, also includes meaning unless the context clearly indicates otherwise, the cardholder, that is, the person presenting for purchase of goods and/or services a payment option such as a card-based payment option. The card-based payment option is identified by the card ISO number as described herein.

The term “hybrid payment authorization”, as recognized and understood by one of ordinary skill in the art based upon the disclosure herein, also includes meaning the novel and effective payment authorization methods and/or systems, as described herein, that provide in a single system both for online mode and offline mode authorization for card-based payment options, and the term “hybrid payment authorization” includes meaning die term “a hybrid system”, that is, a single hybrid payment authorization online and offline system, that is, a hybrid payment authorization system having multiple operating states that includes the meaning of a single hybrid system for authentication of card-based payment options utilizing one or more systems and/or methods of the invention, as described herein, that is, hybrid payment authorization methods and systems as disclosed herein having multiple operating states such as online and offline, and includes meaning a single system having multiple operating states, as described herein, including for example but not limited to, when the single system is online, as described herein, that is, a time when there is a completely functioning data connection, or when the single system is offline, as described herein, that is, a time when the data connection is not completely functioning including whenever data connection is lost and/or there are technical problems with data connectivity and/.or an authorization processor is down, for example but not limited to, unreachability and/or returning errors, and the term “hybrid payment authorization” includes meaning, in one or more embodiment of the invention, for example and not limited by example, to a system with components including a single hybrid payment authorization online and offline system, that is, a hybrid payment authorization system having multiple operating states that includes the meaning of utilizing a transaction local processing unit that connects to a point-of-sale system and provides authorization and activation interface between the point-of-sale system, the central authentication servers or internal authorization provider and the customer, and either (a) an authorization connection to remote servers containing account information, card information, driver info oration, credit information, product restriction, authentication and transactional information, or (b) a local list, that is, an offline list, of cards and account information relating to card-based payment options, which offline list always allows the ability to transact: a specific product or specific products regardless of the account balance or other account information of the state of data connectivity to or communication with the one or more central servers after the authentication step has been successfully completed to the extent the card or account requires the authentication step.

The term “separation of multiple services”, as recognized and understood by, one of ordinary skill in the art, and based upon the disclosure herein, also includes meaning a central server providing one or more computer services relating to the novel and effective methods and systems of the invention, that is the steps of methods and/or systems for credit-based payment options and hybrid payment authorization, wherein the “central server” may be one or more servers providing “multiple services”, which multiple services include, for example but not limited to, a processing application programming interface, that is a processing API, a user interface application programming interface, that is a user interface APE web server, one or more web server running a frontend user interface, that is, a frontend UI, a relational database management system such as the SQL database, and wherein, for example but not limited by example, the multiple services may be divided into one Or more groups such as onto on or more server farm groups and wherein there are one or more servers in each of one or more server farm groups, and, as readily recognized and understood by one of ordinary skill in the art based upon this disclosure, wherein different security policies and/or different protection layers can be applies to the multiple groups based on the function of each group, thereby providing advantages and solutions to disadvantages and problems known in the prior art, tor example but not limited to, (a) where the API is placed on an, internal premier network, that is, a screened network, that is a physical or logical subnet that provides separation between the internal network and other untrusted networks, that is, a demilitarized zone or internal DMZ, and which would be firewalled to specific stores and/or site having the point-of-sale terminals, and where the UI is placed on an external DMZ such as when allowing access for reporting and administration functionalities over the internet connection, and where the SQL database is placed on a trusted network that is fully protected, and (b) where system, that is, computer resources are assigned to match the workload of the function and thereby permitting the scaling, of the system to larger installations, The processing API communicates with the LPU system and contains, inter alia, the business logic for transaction processing, current balance, available credit determination and system health cheeks. The user interface APE contains, inter alia, functions to support any web-based configuration, maintenance and reporting interface. One or more web servers run the front-end user interface and may be used as the primary user interface for personnel at a home office where, central servers may be located and which personnel may then set up new customers, maintain card information, computer drivers, card PINs, and product information, and wherein configuration of the LPU system may be completed by home office personnel, for example but not limited to, product information and/or product mapping. The relational database management system such as the SQL database may be utilized as the data repository for all configuration and transaction data. The computer functions, that is, the computer services, as described above and elsewhere herein, for example, may be run on the same server, or on multiple different servers, as described herein.

The term “point-of-sale operability”, as recognized and understood by one of ordinary skill in the, art, and based upon the disclosure herein also includes meaning the ability of a point-of-sale system, that is, a point-of-sale terminal as part of a single hybrid payment authorization online and offline system, that is, a hybrid payment authorization system having multiple operating states, as described herein, that is the novel and effective systems and/or methods of the invention, the point-of-sale terminal having access to authentication operability via a single payment authorization system, that is, a single hybrid payment authorization system, whether or not the system is online or offline, as described herein, thereby providing customers increased ability to utilize their card-based payment options. The term in “point-of-sale system”, as recognized and understood by one of ordinary skill in the art, and based upon the disclosure herein, also includes meaning point-of-sale terminal, and .may be abbreviated as either POS system or POS terminal.

The term “periodic synthetic test transactions”, as recognized and understood by one of ordinary skill in the art, and based upon the disclosure herein, also includes meaning the local processing unit (“LPU”) system as part of a single hybrid payment authorization online and offline system, that is, a hybrid payment authorization system having multiple operating states, as described herein, that is the novel and effective systems and/or methods of the invention, which system periodically tests, that is periodically conducts synthetic test transactions against the local systems and the central server to determine including data connectivity status and/or the health of the hybrid, system, and after this determination, to set itself, that is, the LPU sets itself into one of three processing modes, namely, online, offline or down, and wherein the term “online”, as recognized and understood by one of ordinary skill in the art, and based upon the disclosure herein, also includes matting normal processing, and wherein the term “offline” , as recognized arid understood by one of ordinary skill in the art, and based upon the disclosure herein, also includes meaning limes when the connectivity between the LNI system and/or the point-of-sale terminal and/or the central server is not completely functioning including whenever data connection is lost and/or there are technical problems with data connectivity and/or an authorization processor is down, for example but not limited to, unreachability and/or returning errors, and in “offline” mode only payment transactions that accept card-based payment information in the “offline list”, as described herein, and wherein the term “down”, that is, “system down”, as recognized and understood by one of ordinary skill in the art, and based upon the disclosure herein, also include meaning a time when there are fatal errors detected in the LPU system, and thereby rejects all requests for payment authorization, and wherein the “offline” mode permits, for example but not limited to, customers such as emergency services customers to purchase goods such as fuel for emergency vehicles regardless of the data connectivity status, d d>also permits any customer to purchase with a card-based payment option any goods and/or services regardless of the data connectivity status. When the periodic synthetic test transactions result in the LPU system setting, itself into “online” mode, that is, is up and running and processing normally, then any remaining previously-completed and stored or in-memory transaction information may be uploaded. The LPU system, as recognized and understood by one of ordinary skill in the art, and based upon the disclosure herein, also includes meaning the LPU system as part of a single hybrid payment authorization online and offline system, that is, a hybrid payment authorization system having multiple operating, states, as described herein, that is the novel and effective systems ardor methods of the invention, where in one or more embodiment of the invention, for example but not limited by example, the LPU system is a computer running Windows or Linux, that is, a fully-embedded Linux system, and is operably connected to one or more point-of-sale systems, that is, point-of-sale terminals at one or more stores, that is, the stores or locations \vitae the goods and/or services are being offered for sale, and which operably connected function, that is “connection”, for example but not limited by example, is done by a serial connection, or is done by an internet protocol (“IP”) telnet to the extent supported by the point-of-sale vendor, and wherein the connection utilizes a standard communication protocol to communicate with multiple POS vendors. The LPU system, as recognized and understood by one of ordinary skill in the art, and based upon the disclosure herein, also includes meaning the LPU system as part of a single hybrid payment authorization online and offline system, that is, a hybrid payment authorization system having multiple operating states, as described herein, that is the novel and effective systems and/or methods of the invention, where in one or more embodiments of the invention, for example but not limited by example, the LPU system is configured minimally, that is, configured to have, for example, the store identification number and the central server URL, and wherein all other configuration not on the LPU system is store, modified and downloaded from the central server during startup, and wherein during the startup, and periodically at times afterwards, processing data, that is, including a list of information relating to cards, that is, card-based payment options and associated processing data, which is the “offline list”, and wherein the offline list does not contain stored-value cards, but rather for example credit cards.

The term “immediate and convenient access”, as recognized and understood by one of ordinary skill in the art, and based upon the disclosure herein regarding a hybrid payment authorization system having multiple operating states, as described herein, that is the novel and effective systems and/or methods of the invention, which term “immediate and convenient access” also includes meaning a customer's access to, that is, guaranteed access to, card-based payment option data required for electronic payment authorization, which access permits a customer to immediately and conveniently utilize a card-based payment option at a point-of-sale terminal as part of the single hybrid payment authorization system of the invention, as described herein, and, for example but not limited by example, thereby providing some customers, for example but not limited to, emergency sere customers having emergency vehicles, access to purchases of fuel for emergency vehicles utilizing card-based payment options.

The term “card-based payment options and hybrid payment authorization”, by utilizing the steps of the methods and/or the systems, all of which are described herein, as recognized and understood by one of ordinary skill in the art based upon this disclosure, also includes meaning, as described herein and in this paragraph, for example in one or more embodiments of the invention, normal processing exemplary steps, in part, following the logic of: the POS requesting from the LPU system an as of a card-based payment option, wherein (a) if the LPU system is in down mode, then the card-based payment option is not authorized, that is, it is rejected, and responds with, for example, a “system down” message, and the payment transaction ends; (b) if the LPU system is in offline mode, then the offline list is checked for card processing information and if the card processing information is found, then that information is retrieved from the offline list and the transaction process continues, as described herein, and if the card processing information is not found, then the card-based payment option is not authorized, that is, it is rejected, and responds with, for example, a “system down” message, and the payment transaction ends; (c) if the LPU system is in online mode, then an encrypted connection is opened to the central server and an authorization request is sent tote central server, which central server responds to the POS with processing data, and wherein if the response is the processing data, then the processing data is used to continue the payment transaction, or for example but not limited to, which central server responds to the POS with a reject message, that is, the processing data is not found, or the card is over credit limit, or the card is locked and is not usable, and wherein if the response is the reject message, then the transaction ends; (d) if the LPU system request to the central server results in a system error, as described herein, or there is no response, then the LPU system resets to the offline mode and the LPU system tries again to authorize payment. After the POS requests from the system an authorization of a card-based payment option, then a transaction object is created in the LPU system and is held in memory, as described herein. For example in one or more embodiments of the invention, the processing data may require, for example, a request for a PIN, which request for a PIN is sent to the POS, and which request for a PIN can be used as a secondary authentication and also may be used to identify which account employee, that is, account customer, is using the card-based payment option, and wherein the system may be configured to have a PIN-specified on the card only, or a list of authorized employee PINs, or a combined list of both of these options, and wherein after the PIN request and after entry via a PIN pad by the account employee, then the entered PIN is compared against the PIN list, as described herein, in the processing data, and wherein if no match is found, then for example but not limited to, an invalid PIN message is sent and the transaction ends, and wherein if the PIN is found or the processing data does not contain a list of PINs for the presented card, then a card result is stored in a transaction object, and an authorization message is sent to the POS, and wherein the authorization message may contain information from the processing data, including but not limited to, the authorized spending limit, the list of allowed products, any one or more responses to any one or more requests for additional data to be entered by the customer, and wherein: (a) the authorized spending limit is, in the case of a stored-value card, it is the amount of money left on the card counting down to zero, or in the case of a standard credit card, it is a soft limit is enforced as understood by one of ordinary skill in the art, and when there is additional credit available, then an approval message for the maximum transaction amount is set, or in the case of the LPU system in offline mode, then, processing stored-value cards is rejected and standard credit cards do not enforce a credit limit; and (b) the list of allowed products may be a list of one or more product codes wherein the POS will restrict the transaction to products contained in the list, or if a restricted product is found in the list, then the POS will respond with a transaction cancelled message; and (c) any one or more responses to any one or more requests for additional data to be entered by the customer, as well as the text of the prompt message, for example but not limited to, odometer reading of a vehicle, driver identification, purchase order number, vehicle number, or any numerical value. For example in one or mom embodiments of the invention, normal processing exemplary steps, in part, continue following the logic of the POS responds with the amount of the purchase and the POS responds with any one or more prompt message, and these POS responses are recorded in a transaction object; and the LPU system responds with a receipt. message, wherein if the transaction involves a stored-value card, then the ETU system will calculate, as described herein, the remaining balance that may be printed on a receipt, and which receipt message is stored in a transaction object, and wherein the POS responds with one or more product codes, quantity and price for all purchased items, and which information is stored in a transaction object. For example in one or more embodiments of the invention, normal processing exemplary steps, in part, continue following the logic of the LPU system responding with a transaction complete message and if in online mode then uploading the transaction object to the central server, or if not in the online mode but rather in offline mode, then the LPU system stores the transaction object in the local database, or if not in online mode and not in offline mode, then the LPU system resets to down mode, and either the transaction is logged to a local log file, or the transaction object is held in memory until the next time it can be uploaded to the central server during a subsequent periodic synthetic test transaction.

Multiple embodiments of the invention, that is, embodiments the invention relating to methods and systems relating to private card payment and hybrid authorization, as recognized and understood by one of ordinary skill in the art based upon this disclosure, that is, as described herein in the abstract, specification, drawings, figures, illustrative examples and claims, disclose novel methods and systems, provide, inter alia, multiple advantages readily recognized and understood by one of ordinary skill in the art based upon this disclosure, and provide, inter alia, advantages over and Solutions to the multiple disadvantages and problems of known methods including those described herein. In some of the following detailed descriptions of multiple, embodiments reference them is reference to the accompanying drawings.

Embodiments the invention relating to methods and systems relating to private card payment and hybrid authorization, as recognized and understood by One of ordinary skill in the art based upon this disclosure, provide multiple advantages and, multiple solutions to the disadvantages and problems of known methods in the prior art described herein, for example but not limited to, without intending to be a complete list: that known electronic payment systems fail to offer a choice other than either a completely online system, that is, a system requiring a completely functioning interact connection, or a completely offline system, that is, a system, operable only during offline periods, that is, a system operable when an internet connection is not functioning; that known electronic payment systems fail to allow for the separation of multiple services such as a processing application programming interface, a user interface website, and a relational database management system: that known electronic payment systems fail to provide a hybrid system, as described herein, that results in continuous point-of-sale operability for card-based payment options; that known electronic payment systems fail to provide a hybrid system, as described herein, that results in guaranteed access to card-based payment option data required for authorization for card-based payment options; that known electronic payment systems fail to provide a hybrid system, as described herein, that results its immediate and convenient access for, customers to card-based payment options; that known electronic payment systems fail to provide a hybrid system, as described herein, that results in multiple point-of-sale terminals that are functional for authorization without maintaining on them an entire database of customer card-based payment option data; that known electronic payment systems fail to provide a hybrid system, as described herein, that results in one system having in one system both and an online states for card-based payment options. Some embodiments having the form of an algorithm, that is, a computer program accessible by a computer-usable or computer-readable medium or memory providing program code for use by or in connection with a computer program, or any instruction execution system, as recognized and understood by one of ordinary skill in the art based upon this disclosure, may also include iterations of one or more of the steps of the invention, that is repeating one of more steps of the invention, that is iterating one or more steps of the invention.

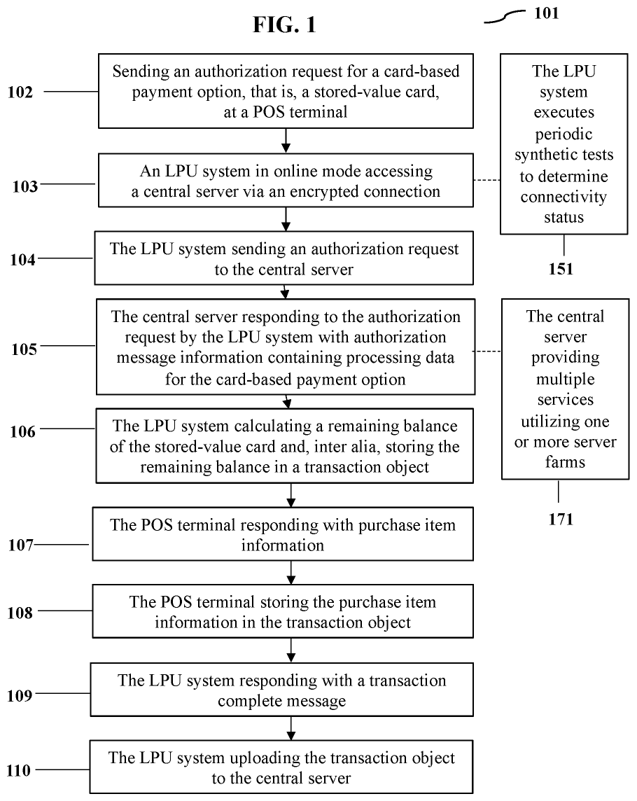

In an embodiment of the invention regarding methods and systems relating to private card payment and hybrid authorization, as recognized and understood by one of ordinary skill the art based upon this disclosure, with references to FIG. 1, which shows in schematic form of a flowchart, an illustrative, exemplary embodiment of the invention 101 where a customer in purchasing goods and/or services, that is, in this embodiment of the invention, goods such as vehicle fuel, presents for payment a card-based payment option, that is, a stored-value card, at a POS terminal in a store having a store identification number, wherein the steps comprise: sending an authorization request for the card-based payment option by the POS terminal to a LPU system in online mode having the store identification number and URI, for a central server 102, the LPU system in online mode accessing the central server via the URI, for the central server by opening an encrypted connection to the, central server 103, the LPU system sending an authorization request to the central server 104, the central server responding to the authorization request of the LPU system with authorization message information including, for example, but not limited to, processing data for the card: based payment option 105, the LPU system calculating, that is, by subtracting the amount of the purchase from the amount on the stored-value card when it was presented by the customer, to make the purchase, thereby resulting in a remaining balance of the stored-value card and printing the remaining balance of the stored-value card on a receipt and storing the remaining balance of the stored-value card in a transaction object 106, the POS terminal responding with purchase item information, that is, for one or more purchased items with one or more product codes for one or more purchased items and a quantity for each one or more purchased items and a price for each for one or more purchased items 107, storing the purchase item information in the transaction object 108, the IT system responding with a transaction complete message 109, the LPU system uploading the transaction object to the central server 110; and wherein the LPU system executes periodic synthetic test transactions to determine the status of the connectivity between the POS terminal and/or the LPU system and or the central server and to set itself in one of three processing modes, that is online mode, offline mode, or down mode 151; and wherein in this embodiment of the invention, the LPU system is set in online mode; and wherein the central server provides the multiple services utilizing one or more server farms having one or more servers in each group 171; and wherein in this embodiment of the invention, one or more security policies and one or more protection layers are applied to one Or more groups based on group function; and wherein processing data for the card-based payment option includes customer account information, card-based payment option information such as card ISO number, card expiration date, billing address, credit card security code, and payment amount, credit information., product restriction information, authentication information, transactional information; and wherein the authorization message information 5Cilt to the POS contains information from the processing data, such as authorized spending limit, list of allowed products, request for additional data to be entered by the customer such as, for example but not limited to, as driver identification, purchase older number, vehicle number, vehicle odometer reading. As evident from the disclosed embodiment, and as recognized and understood by one of ordinary skill in the art, this embodiment of the invention regarding methods and systems relating to private card payment and hybrid authorization, as recognized and understood by one of ordinary skill in the art based upon this disclosure, with reference to FIG. 1, provides multiple objects, features, aspects, and advantages, inter alia, thereby solving the multiple disadvantages and problems of known methods as described herein.

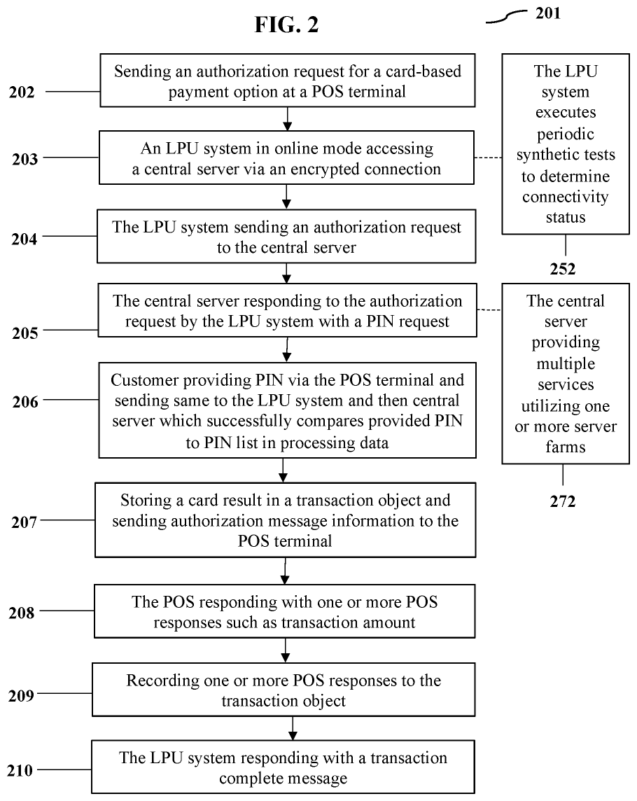

In another embodiment of the invention regarding methods and systems relating to private card payment and hybrid authorization, as recognized and understood by one of ordinary skill in the art based upon this disclosure, with references to Fla 2, which shows in schematic form of a flowchart, an illustrative, exemplary embodiment of the invention 201 where a customer, in purchasing goods and rot services, that is, in this embodiment of the invention, goods such as vehicle fuel, presents for payment a card-based payment option, at a POS terminal in a store having a store identification number, wherein the steps comprise: sending an authorization request for the card-based payment option by the POS terminal to a LPU system in online mode having the store identification number and URL for a central server 202, the LPU system in online mode accessing the central server via the URI, for the central server by opening an encrypted connection to the central server 203, the LPU system sending an authorization request to the central server 204, the central server responding to the authorization request of the LPU system with a request for a PIN required by the processing data 205, the customer providing via the POS terminal PIN pad and sending that PIN to the LPU system and central server, that PIN provided being successfully compared against a PIN list in the processing data 206, storing a card result in a transaction object and sending to the POS terminal an authorization message information 207; the POS terminal responding with one or more POS responses, including for example but not limited to, the amount of the transaction and one or more responses to prompts 208, recording the one or more POS terminal responses to the transaction object 209, the LPU system responding with a receipt message 210; and wherein the LPU system executes periodic synthetic test transactions to determine the status of the connectivity between the POS terminal and/or the LPU system and/or the central server and to set itself in one of three processing modes, that is online mode, offline mode, or down mode 252; and wherein in this embodiment of the invention, the LPU system is set in online mode; and wherein the central server provides the multiple services utilizing one or more server farms having one or more servers in each group 272; and wherein in this embodiment of the invention, one or more security policies and one or more protection layers are applied to one or more groups based on group function; and wherein processing data for the card-based payment option includes customer account information, card-based payment option information such as card ISO number, card expiration date, billing address, credit card security code, and payment amount, credit information, product restriction information, authentication information, transactional information; and wherein the authorization message information sent to the POS contains information from the processing data, such as authorized spending limit, list, of allowed products, request for additional data to be entered by the customer such as, for example hat not limited to, as driver identification, purchase order number, vehicle number, vehicle odometer reading. As evident from the disclosed embodiment, and as recognized and understood by one of ordinary skill in the art, this embodiment of the invention regarding methods and systems relating to private card payment and hybrid authorization, .as recognized and understood by one of ordinary skill in the art based upon this disclosure, with reference to FIG. 2, provides multiple objects, features, aspects, and advantages, inter alia, thereby solving the multiple disadvantages and problems of known methods as described herein.

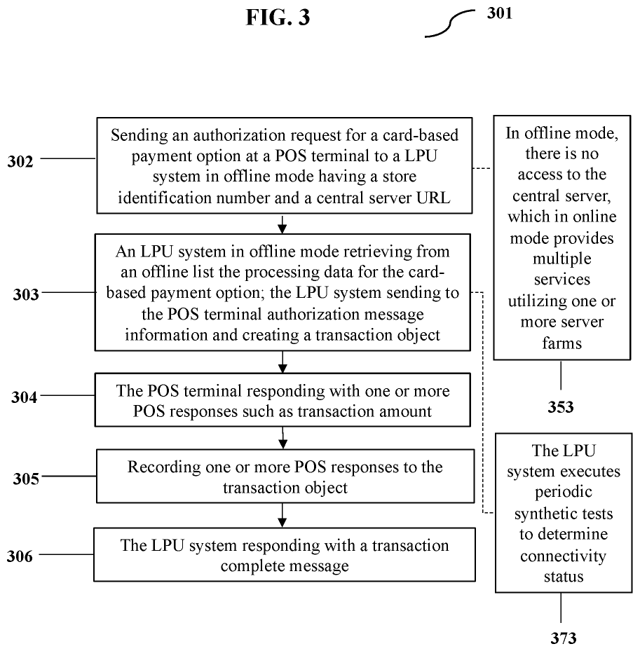

In yet another embodiment of the invention regarding methods and systems relating to private card payment and hybrid authorization, as recognized and understood by one of ordinary skill in the art based upon this disclosure, with references to FIG. 3 which shows in schematic form of a flowchart, an illustrative, exemplary embodiment of the invention 301 where a customer in purchasing goods and/or services, that is, in this embodiment of the invention, presents for payment card-based payment option at a POS terminal in a store having a store identification number, wherein the steps comprise: sending an authorization request for the card-based payment option by the POS terminal to a LPU system in offline mode having the store identification number and URL for a central server 302, the LPU system in offline mode retrieving from an offline list the processing data for the card-basal payment option; the LPU system sending to the POS terminal authorization message information, including for example but not limited to processing data for the card-based payment option and creating a transaction object held in memory 303, the POS terminal responding with one or more POS responses, that is, the amount of the transaction and one or more responses to prompts 304, recording the one or mote POS terminal responses to the transaction object 305, the LPU system responding with a IQ receipt message 306; and wherein the LPU system executes periodic synthetic test transactions to determine the status of the connectivity between the POS terminal and/or the LPU system and/or, the central server and to set itself in one of three processing modes, that is online mode, offline mode, or down mode 353; and wherein, in this embodiment of the invention, the LPU system is set in offline mode; and wherein the central server provides the multiple services utilizing one or more server farms having one or more servers in each group 373; and wherein in this embodiment of the invention, one or more security policies and one or more protection layers are applied to one or more groups based on group function; and wherein processing data for the card-based payment option includes customer account information, card-based payment option information such as card ISO number, card expiration date, billing address, credit card security code, and payment amount, credit information, product restriction information, authentication information, transactional information; and wherein the authorization message information sent to the POS, contains information from the processing data, such as authorized spending limit, list of allowed products, request for additional data to be entered by the customer such as, for example but not limited to, as driver identification, purchase order number, vehicle number, vehicle odometer reading. As evident from the disclosed embodiment, and as recognized and understood by one of ordinary skill in the art, this embodiment of the invention regarding methods and systems relating to private card payment and hybrid authorization, as recognized and understood by one of ordinary skill in the art based upon this disclosure, with reference to FIG. 3, provides multiple objects, features, aspects, and advantages, inter alia, thereby solving the multiple disadvantages and problems of known methods as described herein.

### EXAMPLES

Various features, aspects, and advantages of the invention regarding methods and systems relating to private card payment and hybrid authorization, as recognized and understood by one of ordinary skill in the art based upon this disclosure, are described herein by reference to the following non-limiting examples, which are intended to be illustrative examples, and are representative of, and are illustrative of, some illustrative embodiments of the invention, and are not intended as limiting the scope of the disclosure, as recognized and understood by one of ordinary skill in the art The specification, and including the drawings and figures and abstract and accompanying claims, and including these illustrative examples, provide and enabling disclosure of the invention, sufficient to be recognized and understood by one of ordinary skill in the art so that one of ordinary skill in the art could make and use of the methods and systems without undue experimentation, Thus, some embodiments of the invention can be made and used without departing from the spirit and scope of this disclosure, as recognized and understood by one of ordinary skill in the art.

The illustrative examples described below of the invention regarding methods and systems relating to private card payment and hybrid authorization, as recognized and understood by one of ordinary skill in the art based upon this disclosure, show various features and aspects of the invention and show the invention provides one or more of advantages and solutions over the prior art readily, as apparent and understood by one of ordinary skill in the art based upon this disclosure, the multiple disadvantages and multiple problems of known methods in the prior art listed below, including for example but not limited to, without intending to be a complete list of problems and disadvantages of prior art methods and systems: that known electronic payment systems fail to offer a choice other than either a completely online system, that is, a system requiring a completely functioning internet connection, or a completely offline system, that is, a system operable only during of periods, that is, a system operable when an fauna connection is not functioning; that known electronic payment systems fail to allow for the separation of multiple services such as a processing application programming interface, a user interface website, and a relational database management system; that known electronic payment systems fail to provide a hybrid system, as described herein, that results in continuous point-of-sale operability for card-based payment options; that known electronic payment systems fail to provide a hybrid system, as described herein, that results in guaranteed access to card-based payment option data required for authorization fur cards based payment options; that known electronic payment systems fail to provide a hybrid system, as described herein, that results in immediate and convenient access for customers to card-based payment options; that known electronic payment systems fail to provide a hybrid system, as described herein, that results in multiple point-of-sale terminals that are functional for authorization without maintaining on them an entire database of customer card-based payment option data: that known electronic payment systems fail to provide a hybrid system, as described herein, that results in one system, that is, a single system, that is, the novel and effective methods and, systems for payment authorization during an electronic payment transaction, that is, novel and effective methods and systems relating to card-based payment options and hybrid payments authorization as disclosed herein by, for example but not limited to, the multiple embodiments of the invention and including the examples, thereby having in one hybrid system both online and offline states, which provides the multiple solutions and advantages described herein.

### Example One

In Example 1, a customer is an emergency medical services person (“EMS”) driving an emergency medical services vehicle (“EMS vehicle”) during a severe weather event where high winds have blown down numerous trees as well as power lines and communication lines and communication towers. The EMS is driving the EMS vehicle in a remote part of the region where there are very limited opportunities to re-fuel at a fueling station, and most of the very limited number of fueling stations are closed due to the severe weather event. The EMS drives into a fueling station that utilizes the novel methods and systems disclosed herein, and the EMS presents at the POS terminal in the fueling station store, for the purchase of fuel for the EMS vehicle, a card-based payment option, namely, a stored-value card. As a result of the severe weather event, there is no data connectivity, and the interruption will be extended for at least forty-eight, hours because there is no ability to restore connectivity until well after the severe weather event ends and clean-up begins. However, the EMS needs immediate access to fuel for the EMS vehicle to continue with delivery of emergency services. The EMS presents the stored-value card to the clerk at the fueling station store and the clerk swipes the stored-value card at the POS terminal in the Wing station store, and thereafter the POS terminal sends an authorization request to a LPU system, which system has just completed executing a periodic synthetic test transaction and determined there was no data connectivity and therefore set itself in offline mode. After the authorization request is sent to the LPU system in offline mode, the LPU system retrieves the processing data for the stored-value card that is in an offline list and calculates a remaining balance for the stored-value card after subtracting the amount of the purchase from the amount already on the presented stored-value card. The LPU system sends to the POS terminal authorization message information, including the processing data for the stored-value card, including the EMS's account information and pertinent stored-value card information as described, herein, and the LPU system creates a transaction object held in memory. The POS terminal responds with the amount of the transaction and requested EMS driver identification and EMS vehicle odometer reading, and such responses are recorded to the transaction object. The LPU system responds to the POS terminal with a receipt message that completes the transaction and permits the EMS to immediately purchase the needed fuel for the EMS vehicle even though there is no data connectivity, and permits the EMS to continue with providing emergency services even during the severe weather event.

### Example Two

In Example 2, a customer is an emergency services person (“ESP”) driving an emergency services vehicle (“ES vehicle”) three days after the severe weather event described in. Example 1, and after repairs are completed of all the power lines and communication lines and communication towers. The ESP is driving an ES vehicle, namely, a fire truck in remote part of the region and is on route to back up other ES personnel at a location that is in need of emergency services. Unexpectedly, the ESP realizes there is a need for fuel for the ES vehicle. The ESP needs immediate access to fuel for the ES vehicle to continue with delivery of emergency services. The ESP drives into the same fueling station described in Example 1 that utilizes the novel methods and systems disclosed herein, and the ESP presents at the POS terminal in the fueling station store, for die purchase of fuel for the ES vehicle, a card-based payment option (“the Card”). The ESP presents the Card to the clerk at the fueling station store and the clerk swipes the Card at the POS terminal in the fueling station store, and thereafter the POS terminal sends an authorization request to a LPU system, which system has just completed executing a periodic synthetic test transaction and determined there was data connectivity and therefore set itself in online mode. The authorization request is sent to the LPU system in online mode, which IT system contains the identification number far the fueling station store at which the POS terminal is located as well as the URL for the central server, and which central server is set up at a home office location to provide multiple services utilizing, three server farms with two groups of servers in each group, namely, the processing API and web services, the U1 website, the SQL, database, and wherein the processing API is placed on an internal DMZ and fire walled to this store and other specific stores, and wherein the UI website is placed on an external DMZ in order to allow users to access reporting and administration functions over the internet, and wherein the SQL database is fully protected on the home office trusted network, and wherein the central server computer resources are matched to the workload of these multiple computer functions, that is, computer services. Several months later, the central server configuration set up, that is, the system, is then scaled up to a larger installation. Next, the central server responds to the authorization request of the LPU system in online mode with authorization message information, including processing data for the Card. The POS terminal responds with purchase item information for the purchased item such as the product code for the purchased item and the price, and such purchase item information is stored in a transaction object. The LPU system uploads the transaction object to the central server after first responding with a transaction complete message that completes the transaction and permits the ESP to immediately and conveniently and quickly purchase the needed fuel for the ES vehicle, and permits the EMS to continue with providing emergency services, and which purchase was completed at the same POS terminal of the same fueling station described in Example 1 that utilizes the novel methods and systems disclosed herein, and which permits a card-based payment option hybrid payment authorization in a single, hybrid system having multiple operating states.

The disclosure herein, and including for example the specification, the abstract, and the illustrative examples, and the drawings and, figures, represent various and multiple embodiments of the invention, as understood and recognized by one of ordinary skill in the art, discloses that various additions, modifications and/or substitutions may be made to the embodiments of the invention by one of ordinary skill in the art without departing from the spirit and scope of the principles of the invention, which is defined in the accompanying claims.

Therefore, the various and specific embodiments herein, as well as the examples provided, are to be considered in all respects as illustrative and as examples and as not restrictive and as not limiting the invention. Many possible embodiments of the invention may be made and used and will be readily evident and recognized and understood to one of ordinary skill in the art upon examination of the disclosure of the invention herein. Also, as recognized and understood by one of ordinary skill in the art, there are numerous features and sub-combinations of the invention that may be made and used without reference to other features and sub-combinations. Various objects, features, aspects and advantages of the invention will be readily evident to one of ordinary skill in the art upon examination of the disclosure of the invention herein, including the specification, the abstract, and the illustrative examples, and the drawings and figures, and the appended claims.

What is claimed is:

1. A method for hybrid payment authorization of a card-based payment option, the method comprising the steps of;
presenting, at a point-of-sale terminal, a card-based payment option that is a stored-value card;
sending an authorization request for the stored-value card, from the point-of-sale terminal to a local processing unit system having at least an identification number for the location of the point-of-sale terminal and a uniform resource locator for a central server;
executing periodic synthetic tests to determine connectivity status bet the local processing unit and the central server;
setting a status of the local processing unit to online when there is connectivity between the local processing unit and the central sever;
creating an encrypted connection between the local processing unit system and the central server;
sending an authorization request for the stored-value card, from the local processing unit system to the central server;
sending authorization message information containing processing data for the stored-value card, from the central server to the local processing unit system;
calculating a remaining balance of the stored-value card, by the local processing unit, wherein a payment amount is subtracted from a value amount on the stored-value card;
creating a transaction object storing the remaining balance of the stored-value card, in the local processing unit system;
sending authorization message information, from the local processing unit system to the point-of-sale terminal;
sending purchase item information, from the point-of-sale terminal to the Local processing unit system;
storing the purchase item information in the transaction object;
sending a transaction complete message, from the local processing unit to the point-of-sale terminal;
uploading the transaction object from the local processing unit to the central server;
wherein the central server comprises one or more servers providing at least the services of a processing API, a user interface application programming interface, a web server running a frontend user interface, a relational database management system;
wherein one or more security policies are applied to one or more servers;
wherein one or more protection layers are applied to one or more severs.

2. The method of claim 1 therein the identification number for the location the point-of-sale terminal is a store identification number.

3. A method for hybrid payment authorization of a card-based payment option, the method comprising the steps of:
presenting, at a point-of-sale terminal, a card-based payment option that is a debit card;
sending an authorization request for the debit card, from the point-of-sale terminal to a local processing unit system having at least an identification number for the location of the point-of-sale terminal and a uniform resource locator for a central server;
executing periodic synthetic tests to determine connectivity stains between the local processing unit and the central server;
setting a status of the local processing unit to online when there is connectivity between the local processing unit and the central server;
creating an encrypted connection between the local processing unit system and the central server;
sending an authorization request for the debit card, from the local processing unit system to the central server;
sending a PIN request for to debit card, from the central server to the local processing unit;
sending a PIN entered at the point-of-sale terminal, from the point-of-sale terminal to the local processing unit;
comparing the PIN entered at the point-of-sale terminal to a PIN list in processing data;
storing a card result in a transaction object;
sending authorization message information, from the local processing unit to the port-of-sale terminal;
sending a transaction complete message, from the local processing unit to the point-of-sale terminal;
uploading the transaction object from the local processing unit to the central server;
wherein the central server comprises one or more servers providing at least the services of a processing API, a user interface application programming interface, a web server running a frontend user interface, a relational database management system;
wherein one or more security policies are applied to one or more servers;
wherein one or protection layers are applied to one or more servers;
wherein one or more POS responses are recorded to the transaction object.

4. The method of claim 3 wherein the POS response is a transaction amount.

5. A method for hybrid payment authorization of a card-based payment option, the method comprising the steps of:
presenting, at a point-of-sale terminal, a card-based payment option;
sending an authorization request for the card-based payment option, from the point-of-sale terminal to a local processing unit system having at least an identification number for the location of the point-of-sale terminal and a uniform resource locator for a central server;
executing periodic synthetic tests to determine connectivity status between the local processing unit and the central server;
setting a status of the local processing unit to offline when there is no connectivity between the local processing unit and the central server;
retrieving from an offline list processing data for the card-based payment option, by the local processing unit;
sending authorization message information, from the local processing unit the point-of-sale terminal;
creating a transaction object in the local processing unit;
sending a transaction complete message, from the local processing unit to the point-of-sale terminal;
wherein the central server comprises one or more servers providing at least the services of a processing API, a user interface application programming interface, a web server running a frontend user interface, a relational database management system;
wherein one or more security policies are applied to one or more servers;
wherein one or protection layers are applied to one or more servers;
wherein one or more POS responses are recorded to the transaction object.

6. The method of claim 5 wherein if the local processing unit does not retrieve from the offline list processing data for the card-based payment option, then sending a card rejection system down message.

7. The method of claim 5 wherein if the local processing unit does not connect to the central server, then the status of the local processing unit is set to offline.

8. The method of claim 5 wherein the local processing unit does not upload the transaction object to the central server and stores the transaction object in a local database.

9. The method of claim 8 wherein the local processor does not store the transaction object in a local database and the status is set to down mode and the transaction object is logged to a local log file memory, wherein the transaction held in the local log file memory is uploaded to the central server when the status is set to the online mode.
